(19) United States
(12) Patent Application Publication
(10) Pub. No.: US 2009/0195103 A1
(43) Pub. Date: Aug. 6, 2009

(54) Transmission Systems of Continuously Variable Transmission Ratio

(76) Inventor: Frank Moeller, Stafford (GB)

Correspondence Address: ABELMAN, FRAYNE & SCHWAB, 666 THIRD AVENUE, 10TH FLOOR, NEW YORK, NY, 10017, US

(21) Appl. No.: 12/366,022

(22) Filed: Feb. 5, 2009

(30) Foreign Application Priority Data
Feb. 6, 2008 (GB) 0802226.1

(51) Int. Cl. H02K 16/00

(52) U.S. Cl. 310/156.36; 903/906

(57) ABSTRACT

A transmission system of continuously variable transmission ratio includes an input shaft, an output shaft, first and second electric motor/generators comprising first and second rotors and first and second stators, respectively, at least one of the motor/generators being of axial flux type, the first and second rotors being connected to rotate with respective shafts and the electrical connections of the first and second stators being connected together. A controller is arranged to control the flow of electrical power between the first and second stators. The stator of the said at least one motor/generator comprises two stator portions on opposite sides of the associated rotor, at least one of which is arranged to be movable in the axial direction. The said portion of the stator is rotatably secured to a spigot portion of the associated motor/generator extending in the axial direction by way of cooperating helical formations. An actuator is arranged to rotate one of the said portions of the stator and the spigot relative to the other, thereby moving the said portion of the stator in the axial direction with respect to the associated rotor.

### CROSS-REFERENCE TO RELATED APPLICATIONS

This non-provisional application claims priority to British Patent Application No. 0802226.1 filed in Great Britain on Feb. 6, 2008, the entire contents of which are hereby incorporated by reference.

### BACKGROUND OF THE INVENTION

The present invention relates to transmission systems of continuously variable transmission ratio of the type including an input shaft, an output shaft, first and second electric motor/generators comprising first and second rotors and first and second stators, respectively, at least one of the motor/generators being of axial flux type, the first and second rotors being connected to rotate with respective shafts and the electrical connections of the first and second stators being connected together, a controller arranged to control the flow of electrical power between the first and second stators, the stator of the said at least one motor/generator comprising two stator portions on opposite sides of the associated rotor, at least one of which is arranged to be movable in the axial direction, and an actuator arranged to move the said portion of the stator.

### PRIOR ART

Such a transmission system is disclosed in WO 2008/007125. This document discloses a transmission system with two electrical motor/generators, which are of axial flux type, integrated into a single unit, the rotors of which are connected to respective branches of an epicyclic gearset. Each motor/generator includes a stator which consists of two portions situated on opposite sides in the axial direction of the associated rotor. The two rotors are spaced apart in the axial direction and situated between them is a single stator portion, which is common to both stators. The common stator portion is arranged to be movable in the axial direction and as it moves the air gap of one motor/generator increases whilst the air gap of the other motor/generator decreases and vice versa. This is found to be highly beneficial because the optimum air gap for any electrical machine depends on its operating conditions and it is found that at high speed/low torque a relatively large air gap is desirable whilst at low speed/high torque a relatively small air gap is desirable. In transmission systems of this type, in which one motor/generator generally operates as a generator and supplies its electrical output to the other motor/generator, which operates as a motor, as the speed of one motor/generator increases and its torque decreases, the speed of the other motor/generator decreases while its torque increases. Thus movement of a single stator portion to increase the air gap of one motor/generator and simultaneously decrease the air gap of the other motor/generator can largely optimise the performance of both motor/generators simultaneously.

However, the transmission system of the prior document includes three equi-angularly spaced, axially acting actuators in order to provide the desired axial motion of the common stator portion. The use of three actuators is in practice necessary in order to avoid the risk of the common stator portion becoming skewed, that is to say being moved to a position in which it does not extend truly at right angles to the axis about which the two rotors rotate. The necessity of providing three separate actuators makes the transmission relatively heavy and expensive and furthermore results in the transmission taking up a very considerable amount of space and this may be unacceptable in many automotive applications.

Furthermore, the invention of the prior document is applicable only to those transmission systems in which the two motor/generators are integrated into a single unit. However, this is not always the case and in many transmission systems of the type referred to above the two motor/generators may be situated some considerable distance from one another. Thus the transmission system may be connected to the hub of a motor vehicle with one motor/generator accommodated within the hub and the other situated inboard on the vehicle. The invention of the prior document can of course not be used with such transmission systems but it is nevertheless desirable for the air gap of the motor/generators of such transmission systems to be adjusted in dependence on their operating conditions.

The common portion of the stators in the prior document carries a number of electromagnetic coils in order to define the magnetic stator poles and its movability means that these coils have to be provided with trailing electrical connections. Quite apart from the fact that these connections are susceptible to damage, they are also susceptible to fatigue stress due to their repeated movement and thus to failure in the medium to long term.

It is therefore an object of the invention to provide a transmission system of the type referred to above in which only a single actuator is required, thereby saving both cost and weight and also space. It is a further object to provide a transmission system with the advantages of that disclosed in WO 2008/007125 but which does not necessarily have the two motor/generators integrated into a single unit. Yet a further object is to eliminate the trailing electrical connections which are necessarily provided in the known transmission system.

### SUMMARY OF THE INVENTION

According to the present invention, the said portion of the stator is rotatably secured to a spigot portion of the associated motor/generator extending in the axial direction by way of cooperating helical formations and that the actuator is arranged to rotate one of the said portion of the stator and the spigot portion relative to the other, thereby moving the said portion of the stator in the axial direction with respect to the associated rotor.

Whilst the present invention is concerned primarily with transmission systems, it is believed that a motor or generator, that is to say an electrical machine of axial flux type, with the above features is novel per se and thus according to a further aspect of the present invention, an electrical machine comprises a rotor and a stator, the stator comprising two stator portions on opposite sides of the associated rotor, at least one of which is rotatably secured to a spigot portion connected to the stator and extending in the axial direction by way of cooperating helical formations and an actuator being arranged to rotate one of the said portion of the stator and the spigot portion relative to the other, thereby moving the said portion of the stator in the axial direction with respect to the associated rotor.

The two motor/generators may be separate from one another and it is possible for one of them to be of variable air gap type and for the other to be of fixed air gap type. It is, however, preferred that both motor/generators are of axial flux type and that the first and second stators each comprise two stator portions on opposite sides of the associated rotor, at least one of which is arranged to be movable in the axial direction and respective actuators arranged to move the said portions of the stators, the said portions of the stators being rotatably secured to a spigot portion of the associated motor/generator extending in the axial direction by way of cooperating helical formations, the actuators being arranged to rotate one of the associated said portion of the stator and the associated spigot portion relative to the other, thereby moving the said portion of the stator in the axial direction with respect to the associated rotor. Thus in this preferred embodiment, both motor/generators are of variable air gap type.

The transmission system may be of all electrical type and in this event the rotors of the two motor/generators will necessarily be connected to the input and output shaft, respectively. It is, however, preferred that the transmission includes a differential gearset comprising at least three parallel shafts, two of which constitute the input shaft and the output shaft, respectively, two of which are connected to respective rotors and all of which carry at least one gearwheel in mesh with at least one gearwheel carried by one of the other shafts.

In a preferred embodiment, which is functionally similar to the embodiments disclosed in the prior document referred to above, both motor/generators are of axial flux type and are integrated into a unit with the two rotors mounted coaxially and the first and second stators each comprise two portions, one of which is common to both stators and is connected to a single actuator to be rotated by it. Thus in this embodiment the common stator portion is moved axially by the single actuator to increase the air gap of one motor/generator whilst simultaneously reducing the air gap of the other motor/generator. Whilst the actuator may act on the stator portion to rotate it with respect to a stationary spigot portion, it is also possible for the spigot portion on which the common stator portion is mounted to be rotatable with respect to the stator and for the actuator to be connected to the rotatable spigot portion to rotate it with respect to the common stator portion. In this case, the stator portion will itself not rotate but will be moved only axially by virtue of the cooperating helical formations on the spigot portion and the common stator portion.

The or each movable stator portion may carry a plurality of electromagnetic coils. These coils will of course have to have trailing electrical connections to accommodate movement of the associated stator portion and if the actuator is arranged to rotate the stator portion with respect to the spigot portion on which it is carried, this rotational movement will have to be of limited magnitude to avoid rupturing the electrical connections. In this event, the cooperating helical formations are likely to be in the nature of helical splines arranged such that a relatively small angle of rotation will result in a relatively large movement in the axial direction. Alternatively, the stator portion may be rotationally stationary and the spigot portion may be rotated with respect to it, whereby the only movement performed by the stator portion is in the axial direction.

Alternatively, the or each stator portion may carry no electromagnetic coils and in this event they will constitute only a flux return member and the stator poles will be created by electromagnetic coils provided only on the other portion of the or each stator. In this event there will of course be no trailing electrical connections on the or each movable stator portion which need to be protected and unlimited rotation of the stator portion is therefore possible. In this event, the stator portion may be connected to the spigot portion by cooperating screw threads which perform many revolutions about the central axis. This will permit very much more accurate axial positioning of the stator portion with respect to the spigot portion.

As mentioned above, the or each spigot portion may be stationary and the associated actuator will then be arranged to rotate the said portion of the stator with respect to it. In this event, the or each actuator may be connected to rotate a worm screw, which is in mesh with a worm gear connected to rotate with the said portion of the stator of the associated motor/generator. Alternatively, the spigot portion may be arranged to rotate with respect to the associated motor/generator and the actuator may be arranged to rotate the spigot portion with respect to the said portion of the stator. In this event, the said portion of the stator is rotationally fixed and its movement is only in the axial direction. In this event, the or each actuator may be connected to rotate a worm screw, which is in mesh with a worm gear connected to rotate with a spigot portion of the associated motor/generator.

### BRIEF DESCRIPTION OF THE DRAWINGS

Further features and details of the invention will be apparent from the following description of certain specific embodiments, which is given by way of example only with reference to the accompanying drawings, in which:

FIG. 1 is a scrap axial sectional view of a transmission system in accordance with the invention;

FIG. 2 is an axial sectional view of a single motor/generator for a transmission system in accordance with the invention;

FIG. 3 is an axial sectional view of a modified motor/generator for a transmission system in accordance with the invention;

FIG. 4 is a side view of the actuator used with the motor/generator shown in FIG. 3; and

FIG. 5 is a scrap axial sectional view of a further embodiment of a motor/generator for a transmission system in accordance with the invention.

### DETAILED DESCRIPTION OF THE PREFERRED EMBODIMENTS

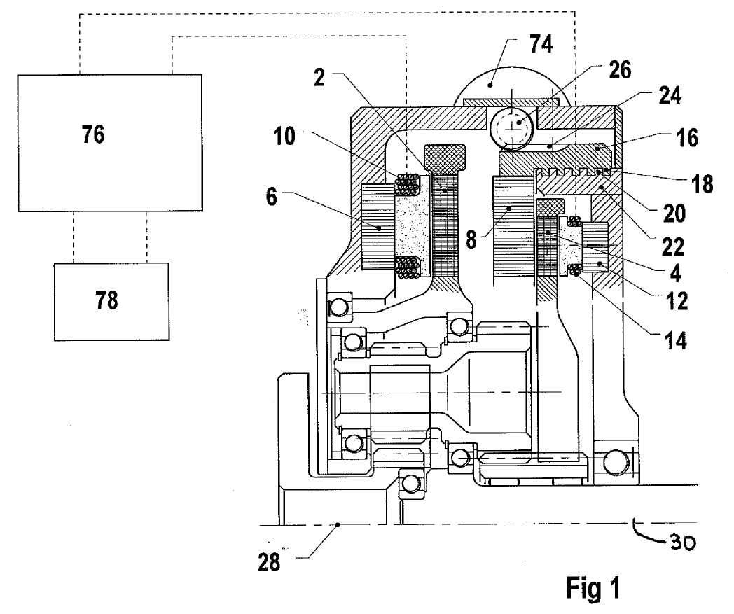

FIG. 1 shows a transmission system including an epicyclic gearset. The gearset is in this case of three branch type but since the gearset is known per se and may be generally the same as the gearsets disclosed in the prior document referred to above, both structurally and functionally, it will not be described in detail in the present application. However, two of the shafts 28, 30 of the gearset constitute an input and an output and two shafts are connected to respective rotors 2, 4 of permanent magnet type of two electric motor/generators. The motor/generator of which the rotor 2 forms part includes a stator consisting of two portions 6 and 8. The stator portion 6 is stationary and includes electromagnetic coils 10, which, in use, define the stator poles. The stator portion 8 carries no electromagnetic coils and therefore constitutes simply a flux return member. The stator portion 8 is made of laminated, grain orientated iron strip wound into a coil. The motor/generator of which the rotor 4 forms part includes a stator which again consists of two portions 8 and 12. The stator portion 12 is stationary and includes further electromagnetic coils 14.

The electromagnetic coils 10, 14 of the two motor/generators are connected together via an electronic controller 76, which is arranged to control the flow of electrical power between the two motor/generators. The controller 76 is also connected to a rechargeable battery 78 and the controller 76 is programmed to withdraw power at appropriate times from that one of the motor/generators which is acting as a generator to recharge the battery and, if and when required, to direct electrical power from the battery to one or even both of the motor/generators, when they are operating as motors, to provide additional input power to the transmission system.

The common stator portion 8 is connected to and carried by an annular support member 16, formed on whose inner surface is a helical formation, in this case a screw thread 18. The screw thread 18 is in mesh with a corresponding screw thread 20 formed on the exterior surface of an annular support spigot or boss 22, which is stationary and connected to the stator member 12. The external surface of the annular support 16 is formed at 24 as a worm wheel, which is in mesh with a worm screw 26. The worm screw 26 is connected to be rotated by an actuator 74. If the actuator is operated, the worm screw 26 is caused to rotate about its axis extending perpendicular to the plane of the drawing and this will result in rotation of the support member 16 and thus of the stator portion 8 about the axis 28 of the transmission system. This rotation is translated by the meshing screw threads 18, 20 into axial movement of the stator portion 8, which may thus be moved as desired from the position shown in FIG. 1 in which the air gap of one motor/generator is at a minimum whilst that of the other is at a maximum to a position in which the former air gap is increased to a maximum and the latter is reduced to a minimum.

The operation of the transmission system is substantially the same as that disclosed in the prior specification referred to above and this will therefore not be described again in detail. However, as will be seen, only a single actuator is necessary in order to produce the required axial displacement of the stator portion 8 and the desired orientation of the stator portion 8 is nevertheless reliably maintained by virtue of the engagement of the two screw threads. Furthermore, the absence of any electromagnetic coils on the stator portion 8 means that there are no trailing electrical connections which are subject to damage or failure.

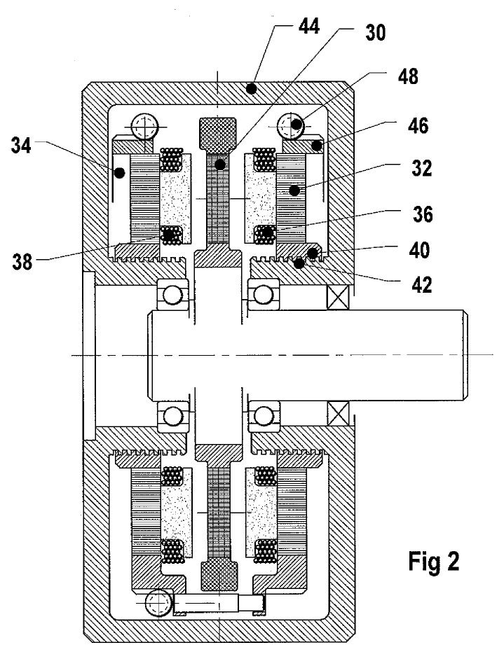

In the embodiment of FIG. 1, only one of the stator portions of each motor/generator is movable. Whilst this may in practice result in a sufficient variation of the air gaps of the two machines, there may be circumstances in which an even greater variation is desirable and an electric motor/generator in which greater air gap variation is possible is shown in FIG. 2. This motor/generator includes a rotor 30 and a stator which again consists of two portions 32 and 34 on opposite sides of the rotor. The stator portions 32, 34 carry respective electromagnetic coils 36, 38. Each stator portion 32, 34 is of annular shape and formed on its inner surface is a screw thread 40, which is in mesh with a corresponding screw thread 42 formed on a stationary spigot integral with the casing of the motor/generator. The outer surface of each stator portion is formed as a worm wheel 46, which is in mesh with a respective worm shaft 48. The two worm shafts 48 are rotated by respective actuators, either independently or together, whereby the two stator portions may be moved in the axial direction as desired so as to vary the air gap on each side of the rotor between a minimum value, which may be close to zero or indeed actually zero, as explained in the prior specification referred to above, and a maximum value. The arrangement of the actuators and worm wheels as described above is illustrated in the top portion of FIG. 2. A slightly modified construction is illustrated in the bottom portion of FIG. 2 in which, as will be seen, only a single actuator is provided which cooperates with only one of the stator portions. However, the two stator portions are connected to rotate together by means of a linkage 50 and the screw threads on the two spigots 44 are oppositely handed. This means that when the single actuator is operated, the two stator portions will rotate together and due to the opposite-handedness of their screw threads, the two stator portions will move in opposite directions, that is to say they will both move away from the associated rotor or towards it. This variant does of course have the advantage that only a single actuator is required.

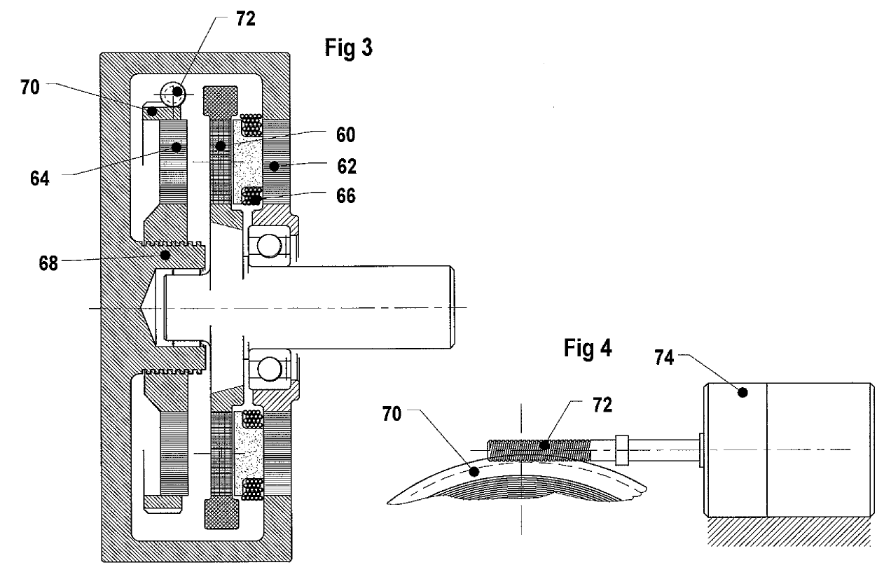

The modified motor/generator shown in FIGS. 3 and 4 is generally similar to that shown in the right-hand half of FIG. 1. Thus the rotor 60 is situated between two stator portions 62 and 64. The stator portion 62 includes electromagnetic coils 66 whilst the stator portion 64 includes no such coils and merely constitutes a flux return member. The stator portion 64 is rotatably carried by way of meshing screw threads on a coaxial spigot 68. The outer periphery of the stator portion 64 is formed as a worm wheel 70, which is in mesh with a worm screw 72. The worm screw 72 is connected to be rotated by an actuator 74. Selective rotation of the actuator 74 will result in rotation of the stator portion 64 about the spigot 68 and thus in axial movement of the stator portion 64 along the spigot 68 towards or away from the rotor 60, thereby altering the air gap.

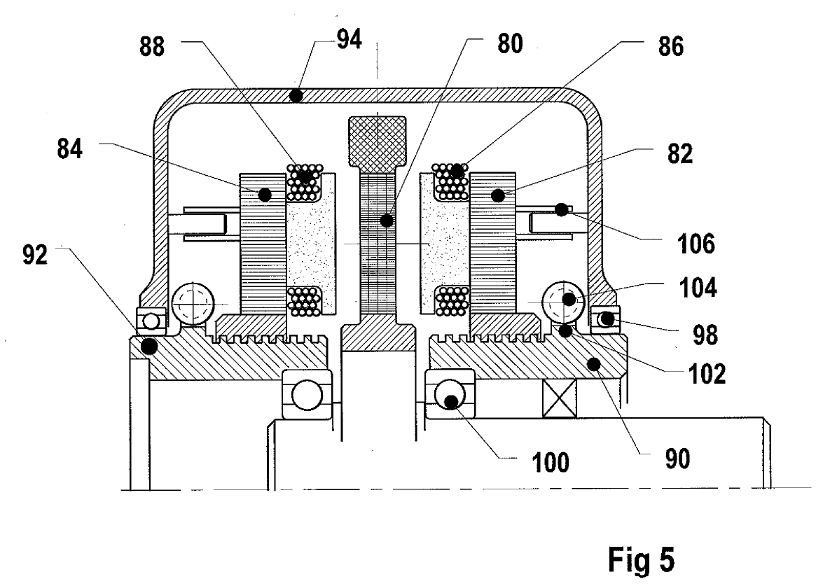

The motor/generator shown in FIG. 5 is similar to that in FIG. 2 in all but one important respect. Thus the rotor 80 is situated between two stator portions 82 and 84, each of which carries respective electromagnetic coils 86 and 88. The stator portions 82 and 84 are again of annular shape and on their inner surfaces carry screw threads, which are in mesh with corresponding screw threads carried by respective spigots 90, 92. However, these spigots are not fixed with respect to the housing of the motor/generator but are instead rotatable with respect to it about the axis of the rotor 80. The spigots are therefore supported with respect to the outer housing 94 and the shaft 96 of the rotor by means of bearings 98 and 100, respectively. Each spigot 90, 92 is formed with a worm wheel 102 on its outer surface, which cooperates with a respective worm screw 104, which is connected to a respective rotary actuator (not shown). When the actuator is operated, the resulting rotation of the worm screw about its longitudinal axis is translated into rotational movement of the spigots 90 about the axis of the rotor 80. This rotational movement is in turn translated into linear axial movement of the stator portions 82 and 84, thereby resulting in turn in alteration of the air gap of the machine. The two stator portions 82, 84 thus do not move in rotation and although they still need to have trailing electrical leads, these leads need accommodate only a relatively small amount of axial movement and no rotational movement. As may be seen, the linearity of movement of the stator portions 82, 84 may be ensured by the provision of one or more linear guides 106.

1. A transmission system of continuously variable transmission ratio including an input shaft, an output shaft, first and second electric motor/generators comprising first and second rotors and first and second stators, respectively, at least one of the motor/generators being of axial flux type, the first and second rotors being connected to rotate with respective shafts and the electrical connections of the first and second stators being connected together, a controller arranged to control the flow of electrical power between the first and second stators, the stator of the said at least one motor/generator comprising two stator portions on opposite sides of the associated rotor, at least one of which is arranged to be movable in the axial direction, and an actuator arranged to move the said portion of the stator, characterised in that the said portion of the stator is rotatably secured to a spigot portion of the associated motor/generator extending in the axial direction by way of cooperating helical formations and that the actuator is arranged to rotate one of the said portion of the stator and the spigot portion relative to the other, thereby moving the said portion of the stator in the axial direction with respect to the associated rotor.

2. A system as claimed in claim 1 in which both motor/generators are of axial flux type and the first and second stators each comprise two stator portions on opposite sides of the associated rotor, at least one of which is arranged to be movable in the axial direction and respective actuators arranged to move the said portions of the stator, the said portions of the stator being rotatably secured to a spigot portion of the associated motor/generator extending in the axial direction by way of cooperating helical formations, the actuators being arranged to rotate one of the associated said portion of the stator and the associated spigot portion relative to the other, thereby moving the said portion of the stator in the axial direction with respect to the associated rotor.

3. A system as claimed in claim 1 including a differential gearset comprising at least three parallel shafts, two of which constitute the input shaft and the output shaft, respectively, two of which are connected to respective rotors and all of which carry at least one gearwheel in mesh with at least one gearwheel carried by one of the other shafts.

4. A system as claimed in claim 2 in which both motor/generators are of axial flux type and are integrated into a unit with the two rotors mounted coaxially and the first and second stators each comprise two portions, one of which is common to both stators and is connected to a single actuator to be rotated by it.

5. A system as claimed in claim 1 in which the or each of the said portions carries a plurality of electromagnetic coils.

6. A system as claimed in claim 1 in which the or each of the said portions carries no electromagnetic coils and thus constitutes only a flux return member.

7. A system as claimed in claim 1 in which the or each spigot portion is stationary and the associated actuator is arranged to rotate said portion of the stator with respect to it.

8. A system as claimed in claim 7 in which the or each actuator is connected to rotate a worm screw, which is in mesh with a worm gear connected to rotate with the said portion of the stator of the associated motor/generator.

9. A system as claimed in claim 1 in which the spigot portion is arranged to rotate with respect to the associated motor/generator and the actuator is arranged to rotate the spigot portion with respect to the said portion of the stator.

10. A system as claimed in claim 9 in which the or each actuator is connected to rotate a worm screw, which is in mesh with a worm gear connected to rotate with the spigot portion of the associated motor/generator.
